(19) United States
(12) Patent Application Publication
(10) Pub. No.: US 2016/0004855 A1
(43) Pub. Date: Jan. 7, 2016

(54) LOGIN USING TWO-DIMENSIONAL CODE

(71) Applicant: Alibaba Group Holding Limited, Grand Cayman (KY)

(72) Inventors: Zhiyuan Lin, Hangzhou (CN); Lianghong Huang, Hangzhou (CN)

(21) Appl. No.: 14/789,791

(22) Filed: Jul. 1, 2015

(30) Foreign Application Priority Data
Jul. 3, 2014 (CN) 201410315942.9

(51) Int. Cl. G06F 21/34; G06F 21/36; G06F 21/35

(52) U.S. Cl. CPC G06F 21/34; G06F 21/35; G06F 21/36

(57) ABSTRACT

After a client terminal successfully logs into a website through a mobile terminal by using user information and password information, a corresponding relationship between the client terminal and the user information is recorded. When the client terminal logs into the website again, the mobile terminal determines that the client terminal is allowed to log into the website through a two-dimensional code by using the corresponding relationship. The mobile terminal acquires a security identification corresponding to the client terminal, generates a two-dimensional code by using the security identification, and displays the two-dimensional code. Upon a receipt of a scanning command from the client terminal, the mobile terminal determines that the client terminal logs into the website through the two-dimensional code. The techniques of the present disclosure do not require the user to input username and password into a login interface repeatedly and improve the user experience in website login.

### CROSS-REFERENCE TO RELATED PATENT APPLICATION

This application claims foreign priority to Chinese patent Application no. 201410315942.9 filed on Jul. 3, 2014, entitled “METHOD AND DEVICE FOR LOGIN USING TWO-DIMENSIONAL CODE,” which is hereby incorporated by reference in its entirety.

### TECHNICAL FIELD

The present disclosure relates to the field of Internet technologies, and, more particularly, to a method and device of login using two-dimensional code.

### BACKGROUND

In conventional techniques, when a user need to log into a website, a server of the website usually displays a login interface on a mobile terminal of the user, and the login interface is composed of items such as username and password. Afterwards, the user inputs correct information such as a username and a password in the login interface of the mobile terminal, and the mobile terminal transmits the information such as the username and the password input by the user to the server of the website, and then the server verifies whether the username and the password input by the user are correct to determine whether the user is allowed to log into the website or not.

In such conventional techniques, each time when the user logs into the website, the user needs to input the information such as the username and the password. Since the password is usually composed of a complex character string, it is inconvenient for the user to input the password, which affects the user experience. In addition, if the user forgets the password, the user cannot log into the website.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure provides a method and a device of two-dimensional code login to relieve the users from inputting information such as a username and a password into a login interface and improve the user experience in website login.

The present disclosure provides a method of two-dimensional code login, which is applied to a mobile terminal. When a client terminal on the mobile terminal needs to log into a website through a two-dimensional code, the method may include the following operations.

After a client terminal successfully logs into the website through a mobile terminal by using user information and password information, a corresponding relationship between the client terminal and the user information is recorded.

When the client terminal logs into the website again, the mobile terminal determines whether the client terminal is allowed to log into the website through a two-dimensional code or not by using the corresponding relationship.

If a result is positive, the mobile terminal acquires a security identification (which may be expressed as SecurityId) corresponding to the client terminal. The mobile terminal generates a two-dimensional code by using the SecurityId and displays the two-dimensional code.

The mobile terminal receives a command from the client terminal to scan the two-dimensional code. Upon the receipt of the command, the mobile terminal determines that the client terminal logs into the website through the two-dimensional code.

Prior to that the mobile terminal acquires the security identification or SecurityId corresponding to the client terminal, the method may further include the following operation. Upon the receipt of a login request initiated by the client terminal, the mobile terminal displays a login interface which needs a user to input user information and receives the user information input by the user in the login interface. The mobile terminal determines whether the user is a code scanning login user. If the user is the code scanning login user, the mobile terminal executes a process of acquiring the SecurityId corresponding to the client terminal. The code scanning login user is a user who logs into a website through a two-dimensional code by using the client terminal.

The process of determining, by the mobile terminal, whether the client terminal is allowed to log into the website through the two-dimensional code or not by using the corresponding relationship may include the following operations.

If the user information input by the user in the login interface is identical with user information recorded in the corresponding relationship and the client terminal which logs into the website again is identical with a client terminal recorded in the corresponding relationship, the mobile terminal determines that the client terminal is allowed to log into the website through the two-dimensional code; otherwise, the mobile terminal determines that the client terminal is not allowed to log into the website through the two-dimensional code.

The process of determining, by the mobile terminal, whether the user is the code scanning login user may include the following operations.

After acquiring the user information, the mobile terminal performs a verification of the user information. If the verification fails, the mobile terminal determines that the user is not the code scanning login user. If the verification succeeds, the mobile terminal queries a user database by using the user information. The user database records a corresponding relationship among user information, user login modes, and user description information. If the user information is not recorded in the user database, the mobile terminal determines that the user is not the code scanning login user. If the user information is recorded in the user database, the mobile terminal determines a user login mode corresponding to the user information. If the user login mode corresponding to the user information does not support code scanning login, the mobile terminal determines that the user is not the code scanning login user. If the user login mode corresponding to the user information supports code scanning login, the mobile terminal determines user description information corresponding to the user information. If the user description information corresponding to the user information is a non-wireless area user, the mobile terminal determines that the user is not the code scanning login user. If the user description information corresponding to the user information is a wireless area user, the mobile terminal determines that the user is the code scanning login user. For example, the wireless area user may refer to a user that has wireless access through the mobile terminal. The non-wireless area user may refer to a user that has cable internet access through a desktop computer.

The process of acquiring, by the mobile terminal, the security identification SecurityId corresponding to the client terminal may include the following operations.

The mobile terminal acquires the SecurityId corresponding to the client terminal by using the user information and records a corresponding relationship between the user information and the SecurityId. The SecurityId is a unique identification corresponding to the client terminal.

The process of determining by the mobile terminal upon the receipt of the command, that the client terminal logs into the website through the two-dimensional code may include the following operations.

Upon the receipt of the command for the client terminal to scan the two-dimensional code, the mobile terminal determines the SecurityId corresponding to the two-dimensional code scanned by the client terminal, queries the corresponding relationship between the user information and the SecurityId through the SecurityId corresponding to the two-dimensional code to acquire the user information corresponding to the SecurityId corresponding to the two-dimensional code, and executes a process of logging into the website for the client terminal by using the user information.

For example, the SecurityId is a SecurityId with expiration time and the two-dimensional code is a two-dimensional code with expiration time.

The present disclosure further provides a mobile terminal. The mobile terminal may include the following modules or units.

A recording module, after the client terminal on the mobile terminal successfully logs into the website through user information and password information, records a corresponding relationship between the client terminal and the user information.

A determining module, when the client terminal logs into the website again, determines whether the client terminal on the mobile terminal is allowed to log into the website through a two-dimensional code or not.

An acquiring module, when the client terminal on the mobile terminal is allowed to log into the website through the two-dimensional code, acquires a security identification or SecurityId corresponding to the client terminal.

A generating module generates a two-dimensional code by using the SecurityId and displays the two-dimensional code.

A receiving module receives a command from the client terminal to scan the two-dimensional code.

A logging-in module, upon the receipt of the command, determine that the client terminal logs into the website through the two-dimensional code.

The receiving module may further, before acquiring the security identification SecurityId corresponding to the client terminal and upon the receipt of a login request initiated by the client terminal, display a login interface which needs a user to input user information and receive the user information input by the user in the login interface.

The determining module may further determine whether the user is a code scanning login user. If the user is the code scanning login user, the acquiring module acquires the SecurityId corresponding to the client terminal. The code scanning login user is a user who logs into a website through a two-dimensional code by using the client terminal.

The determining module may, when determining whether the client terminal is allowed to log into the website through the two-dimensional code, determine that if the user information input by the user in the login interface is identical with user information recorded in the corresponding relationship and the client terminal which logs into the website again is identical with a client terminal recorded in the corresponding relationship, the client terminal is allowed to log into the website through the two-dimensional code; otherwise, determine that the client terminal is not allowed to log into the web site through the two-dimensional code.

The determining module may, when determining whether the user is the code scanning login user, may, after acquiring the user information, perform a verification of the user information; if the verification fails, determine that the user is not the code scanning login user; if the verification succeeds, query a user database by using the user information, wherein the user database records a corresponding relationship among user information, user login modes and user description information; if the user information is not recorded in the user database, determine that the user is not the code scanning login user; if the user information is recorded in the user database, determine a user login mode corresponding to the user information; if the user login mode corresponding to the user information does not support code scanning login, determine that the user is not the code scanning login user; if the user login mode corresponding to the user information supports code scanning login, determine user description information corresponding to the user information; if the user description information corresponding to the user information is a non-wireless area user, determine that the user is not the code scanning login user; and if the user description information corresponding to the user information is a wireless area user, determine that the user is the code scanning login user.

The acquiring module may acquire the SecurityId corresponding to the client terminal by using the user information and record a corresponding relationship between the user information and the SecurityId,

The SecurityId is a unique identification corresponding to the client terminal.

The logging-in module may, upon the receipt of the command from the client terminal to scan the two-dimensional code, determine the SecurityId corresponding to the two-dimensional code scanned by the client terminal, query the corresponding relationship between the user information and the SecurityId through the SecurityId corresponding to the two-dimensional code to acquire the user information corresponding to the SecurityId corresponding to the two-dimensional code, and execute a process of logging into the website for the client terminal using the user information.

For example, the SecurityId may be a SecurityId with expiration time and the two-dimensional code may be a two-dimensional code with expiration time.

Compared with conventional techniques, the techniques of the present disclosure at least have the following advantages.

In the example embodiment of the present disclosure, the mobile terminal may generate the two-dimensional code by using the SecurityId (security identification) corresponding to the client terminal directly, thereby preventing a user from inputting information such as a username and a password into a login interface and improving the user experience in website login. Further, with respect to a client terminal which previously logged into the website, the operation of recognition and login authorization is implemented by scanning the two-dimensional code (such as a dynamically generated two-dimensional code with expiration time), and the authorization is implemented by the client terminal installed on the mobile terminal, thereby avoid inputting information such as a username and a password of the website and improving the user experience in login.

### BRIEF DESCRIPTION OF THE DRAWINGS

In order to explain technical solutions of the example embodiments of the present disclosure more clearly, a brief introduction of drawings to be used for describing the example embodiments of the present disclosure is provided below. Apparently, the drawings described below are merely some example embodiments of the present invention, and for those skilled in the art, other drawings may be acquired according to these drawings of the embodiments of the present disclosure without using creative efforts.

FIG. 1 is a flowchart of an example method for logging in by using two-dimensional code according to a first example embodiment of the present disclosure.

FIG. 2 is a flowchart of another example method for logging in by using two-dimensional code according to a second example embodiment of the present disclosure.

FIG. 3 is a structural diagram of an example mobile terminal according to a third example embodiment of the present disclosure.

### DETAILED DESCRIPTION

The technical solutions of the example embodiments of the present disclosure are described below with drawings of the example embodiments of the present disclosure. Apparently, the described embodiments merely represent a part of, and not all of, the embodiments of the present disclosure. Based on the example embodiments of the present disclosure, all other embodiments acquired by those skilled in the art without using creative efforts fall under the protection scope of the present disclosure.

The first example embodiment of the present disclosure is described below.

In terms of the problem existing in the conventional techniques, the first example embodiment of the present disclosure provides a method of two-dimensional code login. The method may be applied to a mobile terminal. For example, the mobile terminal may use a mobile operating system such as iOS. When a client terminal on the mobile terminal needs to log into a website through a two-dimensional code, for example, when an Alipay™ Wallet client terminal on the mobile terminal needs to log into Alipay™ website through the two-dimensional code, when a Wechat™ client terminal on the mobile terminal needs to log into Wechat™ website through the two-dimensional code, or when a Baidu™ client terminal on the mobile terminal needs to log into Baidu™ website through the two-dimensional code, with respect to a client terminal which previously logged in, the techniques of the present disclosure enable such client terminal to implement the operation of recognition and login authorization by scanning the two-dimensional code to avoid inputting information such as a username and a password of the website and improve the user experience in login.

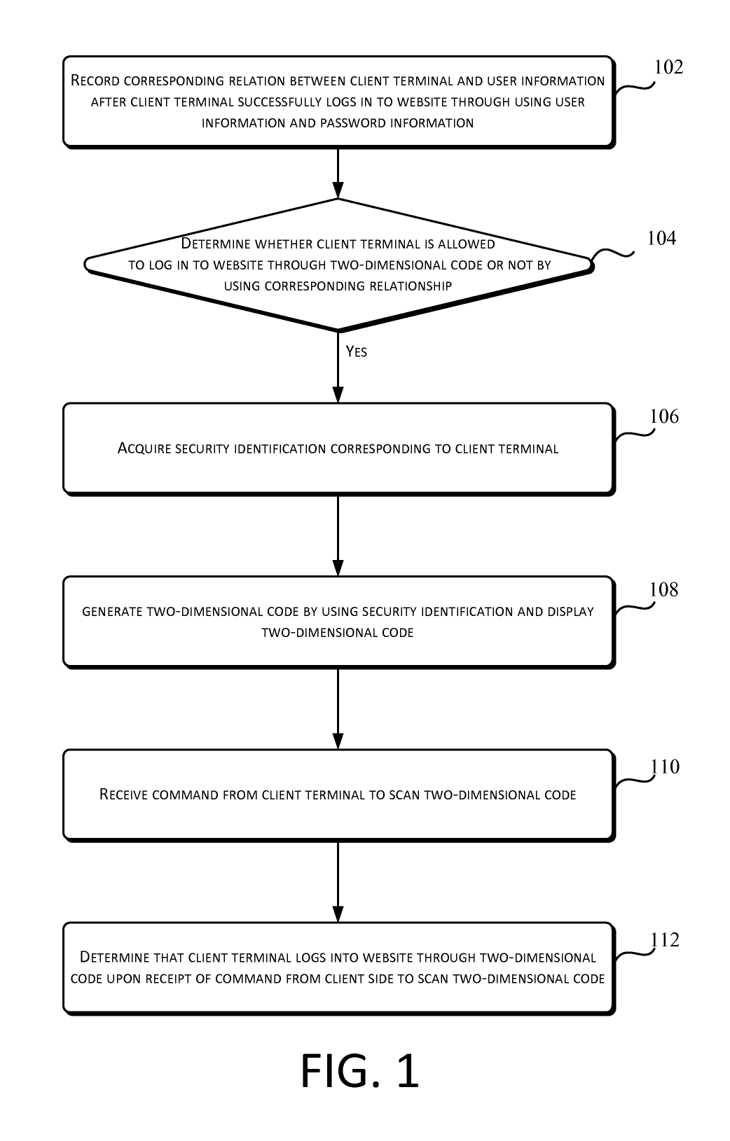

As shown in FIG. 1, the method of two-dimensional code login may include the following operations.

At 102, after the client terminal successfully logs into the website through using user information and password information, the mobile terminal records a corresponding relationship between the client terminal (such as client terminal identification) and the user information.

When the user logs into the website through the client terminal for the first time, a server of the website usually displays a login interface on the mobile terminal of the user, and the login interface may be composed of items such as user information (e.g., username) and password information. Afterwards, the user inputs correct user information (i.e., a username) and password information in the login interface of the mobile terminal, and the mobile terminal transmits the user information and the password information input by the user to the server of the website. The server verifies whether the user information and the password information input by the user are correct or not to determine whether the user is allowed to log into the website or not. If the user is allowed to log into the website, the client terminal may successfully log into the website through the above-mentioned user information and password information. After the client terminal successfully logs into the website through the user information and the password information, the mobile terminal records the corresponding relationship between the client terminal and the user information. If the user is not allowed to log into the website, the user needs to input the user information and the password information again.

Further, after the user is allowed to log into the website and the user has already logged in the website through the client terminal, the client terminal (such as the Alipay™ Wallet client terminal on the mobile terminal, the Wechat™ client terminal on the mobile terminal, and the Baidu™ client terminal on the mobile terminal) is a client terminal which has already logged in. At this point, the mobile terminal will record the corresponding relationship between the client terminal which has already logged in and the user information input by the user.

At 104, when the client terminal logs into the website again, the mobile terminal determines whether the client terminal is allowed to log into the web site through a two-dimensional code or not by using the corresponding relationship. If a result is positive, operations at 106 are executed; otherwise, the existing process will be used for processing, and the user needs to log into the website through the user information and the password information.

In the example embodiment of the present disclosure, when the user logs into the website again through the client terminal which previously logged into the website, the mobile terminal may determine whether the client terminal is allowed to log into the website through the two-dimensional code or not by using the recorded corresponding relationship between the client terminal which has already logged in and the user information input by the user. If the client terminal is allowed to log into the website through the two-dimensional code, operations at 106 will be executed. If the client terminal is not allowed to log into the website through the two-dimensional code, the user logs into the website through inputting the user information and the password information, which is not detailed in the present disclosure.

At 106, the mobile terminal acquires a security identification (which may be expressed as SecurityId) corresponding to the client terminal.

In the example embodiment of the present disclosure, when the client terminal on the mobile terminal needs to log into the website through the two-dimensional code, the client terminal initiates a login request. When the mobile terminal receives the login request initiated by the client terminal, the mobile terminal will display a login interface which needs the user to input user information (such as username), and the user inputs the user information in the login interface. The mobile terminal receives the user information input by the user in the login interface and determines whether the user is a code scanning login user or not by using the user information. If the user is the code scanning login user, the mobile terminal acquires the SecurityId corresponding to the client terminal, i.e., operations at 102 are executed. If the user is not the code scanning login user, the mobile terminal performs a processing according to the existing login process, which is not detailed herein.

For example, the SecurityId is a string of numbers, and the SecurityId is a unique identification corresponding to the client terminal. On this basis, in the example embodiment of the present disclosure, the process of acquiring, by the mobile terminal, the SecurityId corresponding to the client terminal may specifically include, but is not limited to: based on the user information input by the user, acquiring, by the mobile terminal, the SecurityId corresponding to the client terminal by using the user information and recording the corresponding relationship between the user information and the SecurityId. With respect to the user information input by the user, the mobile terminal may convert such user information into a string of numbers through a particular algorithm (such as MD5 algorithm, Hash algorithm and the like), and such string of numbers is the SecurityId corresponding to the client terminal. Further, since the mobile terminal converts the user information into the SecurityId through the particular algorithm, the SecurityId is the unique identification corresponding to the client terminal.

The code scanning login user is a user who is authorized or capable to log into a website through a two-dimensional code by using the client terminal. On this basis, when the user is the code scanning login user, it indicates that the mobile terminal used by the user supports the user to log into the website through the two-dimensional code. For example, a smart phone may support the user to log into the website through the two-dimensional code and the user who uses the smart phone may be the code scanning login user. At this point, the mobile terminal allows the client terminal to adopt the technical solution provided by the example embodiment of the present disclosure, i.e., the mobile terminal allows the client terminal to log into the website through the two-dimensional code. When the user is not the code scanning login user, it indicates that the mobile terminal used by the user cannot support the user to log into the website through the two-dimensional code. For example, a non-smart phone cannot support the user to log into the website through the two-dimensional code and the user who uses the non-smart phone is not the code scanning login user. At this point, the mobile terminal does not allow the client terminal to adopt the technical solution provided by the example embodiment of the present disclosure.

In the example embodiment of the present disclosure, a logging-in module may be set on the mobile terminal, and the logging-in module cooperates with a login center at a server to implement the process that the client terminal logs into the website through the two-dimensional code. On this basis, when the client terminal on the mobile terminal needs to log into the website through the two-dimensional code, the client terminal will initiate a login request. When the mobile terminal receives the login request initiated by the client terminal, the logging-in module interacts with the login center at the server and notifies the login center at the server of the login request initiated by the client terminal. The login center at the server returns a login page to the logging-in module. Then, the logging-in module renders the login page on a browser of the mobile terminal, i.e., a login interface which needs the user to input the user information (such as username) is displayed on the browser of the mobile terminal. The user inputs the user information in the login interface.

In the example embodiment of the present disclosure, based on the user information input by the user in the login interface, at 104, the process of determining, by the mobile terminal, whether the client terminal is allowed to log into the website through the two-dimensional code or not by using the corresponding relationship may specifically include, but is not limited to: if the user information input by the user in the login interface is identical with user information recorded in the corresponding relationship and the client terminal which logs into the website again is identical with a client terminal recorded in the corresponding relationship, determining, by the mobile terminal, that the client terminal is allowed to log into the website through the two-dimensional code; otherwise, determining, by the mobile terminal, that the client terminal is not allowed to log into the website through the two-dimensional code.

In the example embodiment of the present disclosure, the process of determining, by the mobile terminal, whether the user is the code scanning login user or not by using the user information may specifically include, but is not limited to: after acquiring the user information, performing, by the mobile terminal, a verification on the user information; if the verification fails, determining, by the mobile terminal, that the user is not the code scanning login user; if the verification succeeds, querying, by the mobile terminal, a user database by using the user information. The user database records a corresponding relationship among user information, user login modes and user description information. If the user information is not recorded in the user database, the mobile terminal determines that the user is not the code scanning login user. If the user information is recorded in the user database, the mobile terminal determines a user login mode corresponding to the user information. If the user login mode corresponding to the user information does not support code scanning login, the mobile terminal determines that the user is not the code scanning login user. If the user login mode corresponding to the user information supports code scanning login, the mobile terminal determines user description information corresponding to the user information. If the user description information corresponding to the user information is a non-wireless area user, the mobile terminal determines that the user is not the code scanning login user. If the user description information corresponding to the user information is a wireless area user, the mobile terminal determines that the user is the code scanning login user.

In the example embodiment of the present disclosure, a logging-in module may be set on the mobile terminal, and the logging-in module cooperates with a login center at a server to implement the process that the client terminal logs into the website through the two-dimensional code. On this basis, after the mobile terminal acquires the user information, the logging-in module of the mobile terminal interacts with the login center at the server to implement the verification process of the user information. The logging-in module of the mobile terminal transmits the user information to the login center at the server and the login center at the server performs a verification of the user information. If the verification fails, the login center at the server notifies the logging-in module of the information of verification failure, and after the logging-in module receives the information of verification failure, the mobile terminal determines that the user is not the code scanning login user; and if the verification succeeds, the login center at the server notifies the logging-in module of the information of verification success.

After the logging-in module receives the information of verification success, the logging-in module of the mobile terminal interacts with the login center at the server to implement the query process of the user database. The logging-in module of the mobile terminal notifies the login center at the server to query the user database by using the user information (the user database is maintained at the server and is used to record the corresponding relationship among the user information, the user login modes and the user description information). The login center at the server queries for the user database by using the user information. If the user information is not recorded in the user database, the login center at the server notifies the logging-in module that the user information is not recorded in the user database, and after the logging-in module receives such information, the mobile terminal determines that the user is not the code scanning login user. If the user information is recorded in the user database, the login center at the server notifies the logging-in module that the user information is recorded in the user database, and after the logging-in module receives the information, the logging-in module notifies the login center at the server to determine the user login mode corresponding to the user information, and the login center at the server determines the user login mode corresponding to the user information.

If the user login mode corresponding to the user information does not support code scanning login, the login center at the server notifies the logging-in module of the mobile terminal of the information that the user login mode does not support code scanning login, and after the logging-in module receives such information, the mobile terminal determines that the user is not the code scanning login user. If the user login mode corresponding to the user information supports code scanning login, the login center at the server notifies the logging-in module of the mobile terminal that the user login mode supports code scanning login, and after the logging-in module receives such information, the logging-in module notifies the login center at the server to determine the user description information corresponding to the user information. The login center at the server determines the user description information corresponding to the user information. If the user description information corresponding to the user information is a non-wireless area user, the login center at the server notifies the logging-in module of the mobile terminal that the user description information is a non-wireless area user, and after the logging-in module receives such information, the mobile terminal determines that the user is not the code scanning login user. If the user description information corresponding to the user information is a wireless area user, the login center at the server notifies the logging-in module that the user description information is a wireless area user, and after the logging-in module receives such information, the mobile terminal determines that the user is the code scanning login user.

At 108, the mobile terminal generates a two-dimensional code by using the SecurityId and displays the two-dimensional code.

In the example embodiment of the present disclosure, after acquiring the SecurityId corresponding to the client terminal, the mobile terminal may use the SecurityId as input data of the two-dimensional code to generate the two-dimensional code by using the SecurityId. The SecurityId may have expiration time and the two-dimensional code may be a two-dimensional code with expiration time. For example, the valid time of the SecurityId is 30 minutes, and the SecurityId becomes invalid after 30 minutes. At the same time, the valid time of the two-dimensional code is 30 minutes, and the two-dimensional code becomes invalid after 30 minutes.

At 110, the mobile terminal receives a command from the client terminal to scan the two-dimensional code.

In the example embodiment of the present disclosure, after generating the two-dimensional code by using the SecurityId, the mobile terminal will display the two-dimensional code in the login interface of the client terminal. After the user confirms that at present it is necessary to log into the website through the client terminal, the user will scan the two-dimensional code in the login interface of the client terminal and allows the client terminal to send the command of scanning the two-dimensional code. Then, the mobile terminal receives the command for the client terminal to scan the two-dimensional code.

At 112, upon the receipt of the command from the client terminal to scan the two-dimensional code, the mobile terminal determines that the client terminal logs into the website through the two-dimensional code, i.e., the mobile terminal is capable of triggering the client terminal to log into the website through the two-dimensional code.

In the example embodiment of the present disclosure, the process of upon the receipt of the command from the client terminal to scan the two-dimensional code, determining, by the mobile terminal, that the client terminal logs into the website through the two-dimensional code may include, but is not limited to: upon the receipt of the command for the client terminal to scan the two-dimensional code, since the two-dimensional code is generated based on the SecurityId, determining, by the mobile terminal, the SecurityId corresponding to the two-dimensional code scanned by the client terminal, and querying the corresponding relationship between the user information and the SecurityId through the SecurityId corresponding to the two-dimensional code to acquire the user information corresponding to the SecurityId which corresponds to the two-dimensional code; and then executing, by the mobile terminal, a process of directly logging into the website from the client terminal using the user information without inputting the information such as the username and the password.

To summarize, in the example embodiment of the present disclosure, based on the above-mentioned technical solutions, the mobile terminal may generate the two-dimensional code by using the SecurityId (security identification) corresponding to the client terminal directly, which prevents users from inputting information such as a username and a password into a login interface and improves the user experience in website login. Further, with respect to a client terminal which previously logged in, the operation of recognition and login authorization will be implemented by scanning the two-dimensional code (e.g., a dynamically generated two-dimensional code with expiration time), and the authorization will be implemented by the client terminal instead, which avoids inputting information such as a username and a password of the website and thus improves the user experience in login.

The second example embodiment of the present disclosure is described below.

The second example embodiment of the present disclosure provides another method of two-dimensional code login. The method may be applied to a mobile terminal. For example, the mobile terminal may use a mobile operating system such as iOS. When a client terminal on the mobile terminal needs to log into a website through a two-dimensional code, for example, when an Alipay™ Wallet client terminal on the mobile terminal needs to log into Alipay™ website through the two-dimensional code, when a Wechat™ client terminal on the mobile terminal needs to log into Wechat™ website through the two-dimensional code, or when a Baidu™ client terminal on the mobile terminal needs to log into Baidu™ website through the two-dimensional code, with respect to a client terminal which previously logged in, the techniques of the present disclosure enable such client terminal to implement the operation of recognition and login authorization by scanning the two-dimensional code to avoid inputting information such as a username and a password of the website and improve the user experience in login.

In the example embodiment of the present disclosure, the mobile terminal may include at least the following modules: a client terminal (such as an Alipay™ Wallet client terminal, a Wechat™ client terminal, a Baidu™ client terminal, etc.), a browser, a logging-in module and a security module. The client terminal may be a module which needs to log into a website through a two-dimensional code. The logging-in module may cooperate with a login center at a server to implement a process that the client terminal logs into the website through the two-dimensional code. The security module cooperates with a security center at a server to implement a secure login of the client terminal.

In the example embodiment of the present disclosure, after the client terminal successfully logs into the website through user information and password information, the mobile terminal records a corresponding relationship between the client terminal (such as client terminal identification) and the user information. Specifically, when the user logs into the website through the client terminal for the first time, a server of the website usually displays a login interface on the mobile terminal of the user, and the login interface is composed of items such as user information (e.g., a user name) and password information. Afterwards, the user inputs correct user information (e.g., a username) and password information in the login interface of the mobile terminal, and the mobile terminal transmits the user information and the password information input by the user to the server of the website. The server verifies whether the user information and the password information input by the user are correct or not to determine whether the user is allowed to log into the website or not. If the user is allowed to log into the website, the client terminal may successfully log into the website through the above-mentioned user information and password information. At this point, after the client terminal successfully logs into the website through the user information and the password information, the mobile terminal records the corresponding relationship between the client terminal and the user information. If the user is not allowed to log into the website, the user needs to input the user information and the password information again.

Further, after the user is allowed to log into the website and the user has already logged in the website through the client terminal, the client terminal (such as the Alipay™ Wallet client terminal on the mobile terminal, the Wechat™ client terminal on the mobile terminal and the Baidu™ client terminal on the mobile terminal) is a client terminal which has already logged into the website. At this point, the mobile terminal will record the corresponding relationship between the client terminal which has already logged in and the user information input by the user.

On this basis, when the client terminal logs into the website again, the mobile terminal determines whether the client terminal is allowed to log into the website through the two-dimensional code or not by using the above-mentioned corresponding relationship. If a result is positive, the method of two-dimensional code login provided by the second example embodiment of the present disclosure will be adopted to log into the website; and if the result is negative, the existing login process will be adopted for processing and the user will log into the website through inputting the user information and the password information. For example, when the user logs into the website again through the client terminal which previously logged into the website, the mobile terminal determines whether the client terminal is allowed to log into the website through the two-dimensional code or not by using the recorded corresponding relationship between the client terminal which has already logged in and the user information input by the user. If the client terminal is allowed to log into the website through the two-dimensional code, the method of two-dimensional code login provided by the second example embodiment of the present disclosure is adopted to log into the website; and if the client terminal is not allowed to log into the website through the two-dimensional code, the user will log into the website through inputting the user information and the password information, which is not detailed herein.

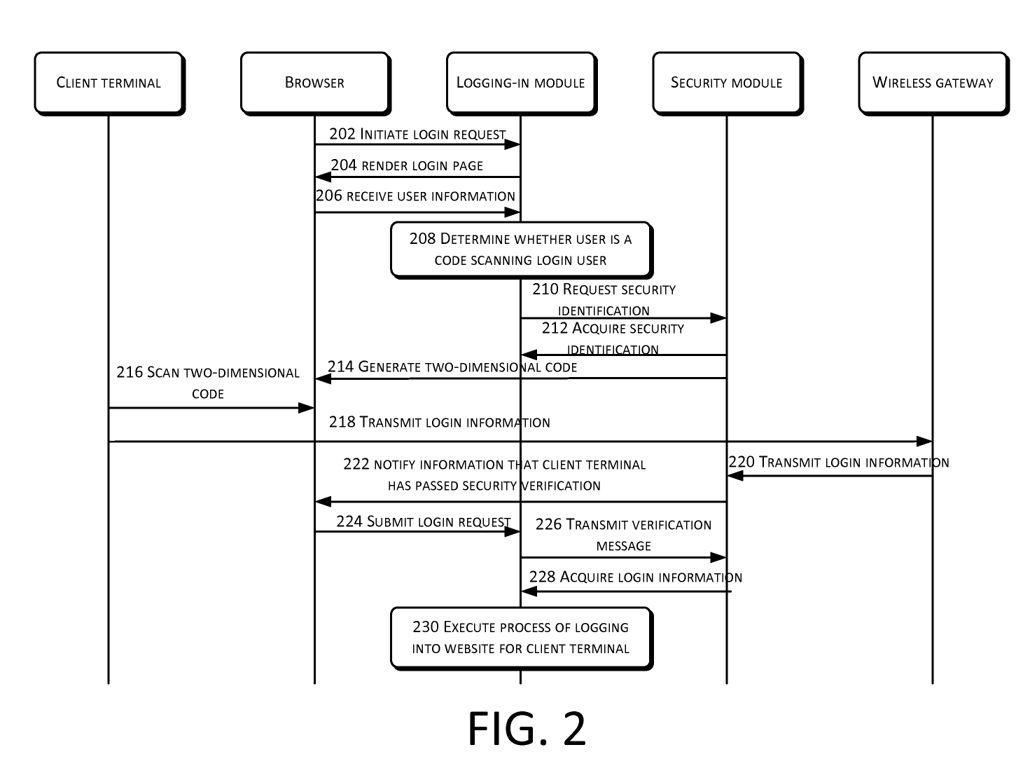

Based on the above-mentioned application scenario, as shown in FIG. 2, the method of two-dimensional code login may include the following operations.

At 202, when the client terminal on the mobile terminal needs to log into the website through using the two-dimensional code, the client terminal initiates a login request through a browser, i.e., the browser transmits the login request to the logging-in module.

At 204, upon the receipt of the login request initiated by the client terminal, the logging-in module renders a login page on the browser, i.e., the logging-in module displays, on the browser, a login interface which needs the user to input user information (such as username, etc.), and the user inputs the corresponding user information in the login interface of the browser.

For example, the logging-in module cooperates with the login center at the server to implement the process that the client terminal logs into the website through the two-dimensional code. On this basis, after the logging-in module receives the login request initiated by the client terminal, the logging-in module interacts with the login center at the server and notifies the login center at the server of the login request initiated by the client terminal, and the login center at the server returns the login page to the logging-in module. Then, the logging-in module renders the login page on the browser, i.e., displays the login interface which needs the user to input the user information (such as username) on the browser, and the user inputs the user information in the login interface.

At 206, the logging-in module receives the user information input by the user in the login interface, i.e., when the user inputs the user information in the login interface of the browser, the logging-in module receives the user information input by the user.

At 208, the logging-in module determines whether the user is a code scanning login user or not by using the user information. If the user is the code scanning login user, operations at 210 are executed; if the user is not the code scanning login user, the processing will be performed according to the existing login process, which is not detailed herein.

For example, the code scanning login user is a user who is authorized or capable to log into a website through a two-dimensional code by using the client terminal. On this basis, when the user is the code scanning login user, it indicates that the mobile terminal used by the user supports the user to log into the website through the two-dimensional code. For example, a smart phone supports the user to log into the website through the two-dimensional code and the user who uses the smart phone is the code scanning login user. At this point, the client terminal is allowed to adopt the technical solution provided by the example embodiment of the present disclosure. When the user is not the code scanning login user, it indicates that the mobile terminal used by the user cannot support the user to log into the website through the two-dimensional code. For example, a non-smart phone cannot support the user to log into the website through the two-dimensional code and the user who uses the non-smart phone is not the code scanning login user. At this point, the client terminal is not allowed to adopt the technical solution provided by the example embodiment of the present disclosure.

In the example embodiment of the present disclosure, the process of determining, by the logging-in module, whether the user is the code scanning login user or not by using the user information may includes, but is not limited to: after acquiring the user information, performing, by the logging-in module, a verification of the user information; if the verification fails, determining, by the logging-in module, that the user is not the code scanning login user; if the verification succeeds, querying, by the logging-in module, a user database by using the user information, wherein the user database is used to record a corresponding relationship among user information, user login modes and user description information; if the user information is not recorded in the user database, determining, by the logging-in module, that the user is not the code scanning login user; if the user information is recorded in the user database, determining, by the logging-in module, a user login mode corresponding to the user information; if the user login mode corresponding to the user information does not support code scanning login, determining, by the logging-in module, that the user is not the code scanning login user; if the user login mode corresponding to the user information supports code scanning login, determining, by the logging-in module, user description information corresponding to the user information; if the user description information corresponding to the user information is a non-wireless area user, determining, by the logging-in module, that the user is not the code scanning login user; and if the user description information corresponding to the user information is a wireless area user, determining, by the logging-in module, that the user is the code scanning login user.

In the example embodiment of the present disclosure, the logging-in module cooperates with the login center at the server to implement the process that the client terminal logs into the website through the two-dimensional code. On this basis, after the logging-in module acquires the user information, the logging-in module interacts with the login center to implement the verification process of the user information. The logging-in module transmits the user information to the login center and the login center performs a verification of the user information. If the verification fails, the login center notifies the logging-in module of the information of verification failure, and after the logging-in module receives the information of verification failure, the logging-in module determines that the user is not the code scanning login user. If the verification succeeds, the login center notifies the logging-in module of the information of verification success. After the logging-in module receives the information of verification success, the logging-in module interacts with the login center to implement the query process of the user database, wherein the logging-in module notifies the login center to query the user database by using the user information (the user database is maintained at the server); and the login center queries for the user database by using the user information. If the user information is not recorded in the user database, the login center notifies the logging-in module that the user information is not recorded in the user database, and after the logging-in module receives such information, the logging-in module determines that the user is not the code scanning login user. If the user information is recorded in the user database, the login center notifies the logging-in module that the user information is recorded in the user database, and after the logging-in module receives such information, the logging-in module notifies the login center to determine the user login mode corresponding to the user information, and the login center determines that the user login mode corresponding to the user information. If the user login mode corresponding to the user information does not support code scanning login, the login center notifies the logging-in module that the user login mode does not support code scanning login, and after the logging-in module receives such information, the logging-in module determines that the user is not the code scanning login user. If the user login mode corresponding to the user information supports code scanning login, the login center notifies the logging-in module that the user login mode supports code scanning login, and after the logging-in module receives such information, the logging-in module notifies the login center to determine the user description information corresponding to the user information, and the login center determines the user description information corresponding to the user information. If the user description information corresponding to the user information is a non-wireless area user, the login center notifies the logging-in module that the user description information is a non-wireless area user, and after the logging-in module receives such information, the logging-in module determines that the user is not the code scanning login user. If the user description information corresponding to the user information is a wireless area user, the login center notifies the logging-in module that the user description information is a wireless area user, and after the logging-in module receives such information, the logging-in module determines that the user is the code scanning login user.

For example, after the logging-in module acquires the user information, the logging-in module may notify the login center at the server of the user information. After the login center acquires the user information, the login center may verify the user information such as through an example function called verifyId.json function, which is called to perform a Radio Data System (RDS) verification of the user information. If the verification fails, it indicates that the user is an invalid user, and the login center outputs a failed verification code directly. At this point, whether the user is the code scanning login user or not will not be recognized and the logging-in module determines that the user is not the code scanning login user.

If the verification succeeds, it indicates that the user is a valid user and the login center further acquires stored user information (which may be called userInfo information) from the user database. If the acquired user information is not included in the userInfo information, it indicates that the account does not exist, and the login center outputs the information directly that the user information is not recorded in the user database, and at this point, the logging-in module determines that the user is not the code scanning login user. If the acquired user information is included in the userInfo information, it indicates that the account exists and the login center further queries for the user login mode from the user database.

If the user login mode does not support code scanning login (which may be expressed as supportScan=fail), it indicates that the user does not support code scanning login, and the login center outputs the information directly that the user does not support code scanning login, and at this point, the logging-in module determines that the user is not the code scanning login user. If the user login mode supports code scanning login (which may be expressed as supportScan=true), it indicates that the user supports code scanning login and the login center further queries for the user description information from the user database. The user description information is profile information recorded in the user database.

If the user description information is non-wireless area user (which may be expressed as Wireless=fail), it indicates that the user is a non-wireless area user, and the login center outputs the information directly that the user is a non-wireless area user, and at this point, the logging-in module determines that the user is not the code scanning login user. If the user description information is wireless area user (which may be expressed as Wireless=true), it indicates that the user is a wireless area user, and the login center outputs the information directly that the user is a wireless area user, and at this point, the logging-in module determines that the user is the code scanning login user, and thus the recognition process of the code scanning login is ended.

In the above-mentioned process, since the user login mode and the user description information are newly added parameters in the user database, there could be a failure in acquiring the user login mode and/or user description information. On this basis, if there is a failure in acquiring the user login mode and/or user description information, the login center outputs the information that there is a failure in acquiring the user login mode and/or user description information directly, and, at this point, the logging-in module determines that the user is not the code scanning login user.

At 210, the logging-in module transmits a message for requesting SecurityId to the security module.

At 212, the security module acquires the SecurityId corresponding to the client terminal and transmits the SecurityId to the logging-in module. The SecurityId is a string of numbers and is a unique identification corresponding to the client terminal.

The security module further needs to record a corresponding relationship between the user information and the SecurityId.

In the example embodiment of the present disclosure, based on the user information input by the user, the security module may acquire the SecurityId corresponding to the client terminal by using the user information. For example, the security module may convert the user information into a string of numbers through a particular algorithm (such as MD5 algorithm, Hash algorithm, and so on), and such string of numbers is the SecurityId corresponding to the client terminal. Further, since the security module converts the user information into the SecurityId through the particular algorithm, the SecurityId is a unique identification corresponding to the client terminal.

Since the security module cooperates with the security center at the server to implement the secure login of the client terminal, the security center will provide a security interface (which may be expressed as querySecurityPolicy interface) to the security module, and the security module may acquire the SecurityId from the security center through the security querySecurityPolicy interface. The security module may acquire, from the security center, two types of SecurityId for two verification modes. One type of SecurityId for one verification mode is SecurityId for code scanning login (which may be expressed as scanCodeSecurityId) and the SecurityId described in the example embodiment of the present disclosure is scanCodeSecurityId; and the other type of SecurityId for the other verification mode is for traditional password login (which may be expressed as passwordSecurityId).

At 214, the security module generates a two-dimensional code by using the SecurityId and displays the two-dimensional code.

In the example embodiment of the present disclosure, after acquiring the SecurityId corresponding to the client terminal, the security module may use the SecurityId as input data of the two-dimensional code to generate the two-dimensional code by using the SecurityId. The SecurityId may be used for generating different two-dimensional codes multiple times, and the SecurityId is a SecurityId with expiration time and the two-dimensional code is a two-dimensional code with expiration time. For example, a valid time of the SecurityId may be set as 30 minutes, and the SecurityId becomes invalid after 30 minutes. At the same time, a valid time of the two-dimensional code may be set as 30 minutes, and the two-dimensional code becomes invalid after 30 minutes. On this basis, after 30 minutes, the security module needs to re-acquire the SecurityId and re-generate the two-dimensional code by using the re-acquired SecurityId.

In the example embodiment of the present disclosure, after the security module generates the two-dimensional code, the security module renders a code scanning page on the browser, i.e., the security module displays the code scanning page including the two-dimensional code on the browser, and the user scans the two-dimensional code.

At 216, after the code scanning page including the two-dimensional code is displayed on the browser, and when the user confirms that at present it is necessary to log into the website through the client terminal, the user will scan the two-dimensional code on the code scanning page of the browser. In other words, the client terminal will send a command of scanning the two-dimensional code. At this point, the process of scanning the two-dimensional code is ended.

In the example embodiment of the present disclosure, the code scanning page including the two-dimensional code which can be displayed includes, but is not limited to pages generally expressed as index, homeB, xbox, express, miniExpress, exterface, payment, iframe, etc.

At 218, the client terminal transmits login information to a wireless gateway (i.e., a wireless gateway corresponding to an application of the client terminal).

At 220, the wireless gateway transmits the login information to the security module through the security center.

At 222, the security module notifies the browser of the information that the client terminal has already passed security verification.

At 224, the browser submits a login request to the logging-in module. The login request includes the SecurityId.

In the example embodiment of the present disclosure, since the code scanning page including the two-dimensional code is displayed on the browser, and the two-dimensional code is generated based on the SecurityId, the browser determines the SecurityId corresponding to the two-dimensional code scanned by the client terminal, and when the login request is submitted to the logging-in module, the SecurityId is carried in the login request.

At 226, the logging-in module transmits a verification message carrying the SecurityId to the security module.

At 228, the security module acquires login information corresponding to the SecurityId, and returns the login information corresponding to the SecurityId to the logging-in module. The login information may be user information.

In the example embodiment of the present disclosure, the corresponding relationship between the user information (such as username) and the SecurityId is recorded by the security module. Therefore, upon the receipt of the verification message carrying the SecurityId, the security module queries the corresponding relationship between the user information and the SecurityId by using the SecurityId to acquire the user information corresponding to the SecurityId and return the user information corresponding to the SecurityId to the logging-in module.

At 230, according to the login scenario, the logging-in module executes a process of logging into the website directly for the client terminal associated with the user information without inputting information such as the username and the password, and renders a target address to the browser.

In the above-mentioned login process from 218 to 230, after the client terminal transmits the login information to the wireless gateway and passes the verification, the login center will be notified that a form is submitted at a front-end page and whether the token of the form is valid or not is checked. Further, after the form submission, a security kernel interface is called to acquire the user information. If there is a failure in acquiring the user information, error information is rendered. Further, in a login scenario for payment, whether the user state is normal or not also needs to be checked, and an unauthorized user for the website (such as the user is not registered at Taobao™ website or a non-T user) cannot log in. In an express login scenario (which may use express key for logging in), whether unique parameters of the express login scenario are normal or not need to be checked as well, such as parameters IW_PARTNER_ID, IW_PARTNER_EXTERFACE_NAME, etc.

In the above-mentioned login process from 218 to 230, after acquiring the login information (such as user login identification, i.e., user information) corresponding to the SecurityId, the logging-in module may perform a fake login such as through calling a fakeLogin interface of cif. The fakeLogin triggers a CTU event. If the cif login fails, the logging-in module renders a corresponding error prompt; if the cif login succeeds, the login process is ended. After the login succeeds, information such as P3P header, session context, permission, cookie and the like may also be set, and some operations such as account stolen and RDS check do not need to be executed.

To sum up, in the example embodiment of the present disclosure, based on the above technical solution, the mobile terminal may generate the two-dimensional code by using the SecurityId (security identification) corresponding to the client terminal directly, thereby preventing the user from inputting information such as a username and a password into a login interface and improving the user experience in website login. Further, for a client terminal which previously logged in, the operation of recognition and login authorization will be implemented by scanning the two-dimensional code (such as the dynamically generated two-dimensional code with expiration time), and the authorization will be implemented by the client terminal instead, thereby avoiding inputting information such as a username and a password of the website and improving the user experience in login.

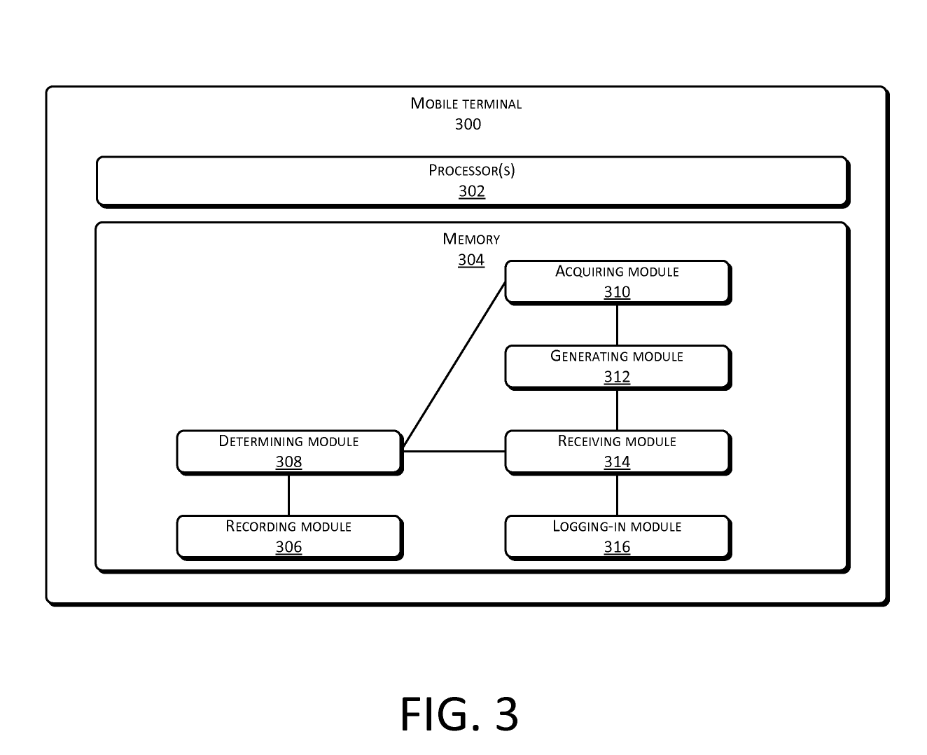

Based on the same concept as that of the above-mentioned method, the example embodiment of the present disclosure further provides a mobile terminal. As shown in FIG. 3, an example mobile terminal 300 may include one or more processor(s) or data processing unit(s) 302 and memory 304. The mobile terminal 300 may further include one or more input/output devices and network interfaces (not shown in FIG. 3). The memory 304 is an example of computer readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 304 may store therein a plurality of modules or units as follows.

A recording module 306 that, after a client terminal on the mobile terminal successfully logs into a website through user information and password information, records a corresponding relationship between the client terminal and the user information;

A determining module 308 that, when the client terminal logs into the website again, determines whether the client terminal on the mobile terminal is allowed to log into the website through a two-dimensional code or not by using the corresponding relationship;

An acquiring module 310 that, when the client terminal on the mobile terminal is allowed to log into the website through the two-dimensional code, acquires a security identification (which may be expressed as SecurityId) corresponding to the client terminal;

A generating module 312 that generates a two-dimensional code by using the SecurityId and displays the two-dimensional code;

A receiving module 314 that receives a command from the client terminal to scan the two-dimensional code; and

A logging-in module 316 that, upon the receipt of the command, determines that the client terminal logs into the website through the two-dimensional code.

The receiving module 314 may further, before acquiring the security identification SecurityId corresponding to the client terminal and upon the receipt of the login request initiated by the client terminal, display a login interface which needs a user to input user information and receive the user information input by the user in the login interface. The determining module 308 may further determine whether the user is a code scanning login user or not by using the user information; and if the user is the code scanning login user, the acquiring module 310 acquires the SecurityId corresponding to the client terminal. The code scanning login user is a user who is authorized to or capable to log into a website through a two-dimensional code by using the client terminal.

The determining module 308, when determining whether the client terminal is allowed to log into the website through the two-dimensional code or not by using the corresponding relationship, may determine that the client terminal is allowed to log into the website through the two-dimensional code if the user information input by the user in the login interface is identical with user information recorded in the corresponding relationship and the client terminal which logs into the web site again is identical with a client terminal recorded in the corresponding relationship; otherwise, the determining module 308 may determine that the client terminal is not allowed to log into the website through the two-dimensional code.

The determining module 308, when determining whether the user is the code scanning login user or not by using the user information, may perform verification of the user information after acquiring the user information. If the verification fails, the determining module 308 determines that the user is not the code scanning login user. If the verification succeeds, the determining module 308 queries a user database by using the user information. The user database records a corresponding relationship among user information, user login modes and user description information. If the user information is not recorded in the user database, the determining module 308 determines that the user is not the code scanning login user. If the user information is recorded in the user database, the determining module 308 determines a user login mode corresponding to the user information. If the user login mode corresponding to the user information does not support code scanning login, the determining module 308 determines that the user is not the code scanning login user. If the user login mode corresponding to the user information supports code scanning login, the determining module 308 determines user description information corresponding to the user information. If the user description information corresponding to the user information is a non-wireless area user, the determining module 308 determines that the user is not the code scanning login user. If the user description information corresponding to the user information is a wireless area user, the determining module 308 determines that the user is the code scanning login user.

The acquiring module 310 may acquire the SecurityId corresponding to the client terminal by using the user information and record a corresponding relationship between the user information and the SecurityId. The SecurityId is a unique identification corresponding to the client terminal.

The logging-in module 316 may, upon the receipt of the command for the client terminal to scan the two-dimensional code, determine the SecurityId corresponding to the two-dimensional code scanned by the client terminal, query the corresponding relationship between the user information and the SecurityId through the SecurityId corresponding to the two-dimensional code to acquire the user information corresponding to the SecurityId corresponding to the two-dimensional code, and execute a process of logging into the website for the client terminal using the user information.

In the example embodiment of the present disclosure, the SecurityId may be a SecurityId with expiration time and the two-dimensional code may be a two-dimensional code with expiration time.

The modules of the terminal, apparatus or device of the present disclosure may be either integrated or deployed separately. The above-mentioned modules may be either combined as one module or further divided into a plurality of sub-modules.

By the preceding description of the embodiments, persons skilled in the art should clearly understand that the present disclosure may be implemented via software plus the necessary general hardware platform, and may be implemented via hardware alone. Based on such understanding, the technical solution of the present disclosure, or the portion of the application that makes contribution to the state of the art, may be embodied in the form of a software product that is stored in memory that stored thereon a plurality of computer-executable instructions enabling a computer device (which can be a personal computer, a server, a network device, and so on) to execute the methods recited in the embodiments of the present disclosure. Those skilled in the art may appreciate that the FIGs are merely a schematic diagram of example embodiment and the modules or flows in the FIGs may not be necessarily used to implement the present disclosure into practice. Those skilled in the art may appreciate that the modules in the terminal, apparatus, or device in the example embodiment may be distributed in the terminal, apparatus, or device as described in the embodiment or may be modified correspondingly to be arranged in one or more apparatuses other than those in the example embodiments. The modules in the foregoing example embodiment may be combined into one module or be further divided into a plurality of sub-modules. The example embodiments of the present disclosure have been numbered only for the purpose of description, and this will not indicate any superiority of one embodiment to another. The present disclosure only illustrate several example embodiments of the present disclosure, but the present disclosure will not be limited thereto and any variations which may occur to those skilled in the art shall come into the protection scope of the present disclosure.

What is claimed is:

1. A method comprising:
recording, by a mobile terminal, a corresponding relationship between a client terminal and first user information after the client terminal at the mobile terminal successfully logs into a website; and
determining, by the mobile terminal, that the client terminal is allowed to log into the website through a two-dimensional code by using the corresponding relationship when the client terminal logs into the website again.

2. The method of claim 1, further comprising:
acquiring, by the mobile terminal, a security identification corresponding to the client terminal;
generating, by the mobile terminal, the two-dimensional code by using the security identification; and
displaying the two-dimensional code.

3. The method of claim 2, further comprising:
receiving, by the mobile terminal, a command from the client terminal to scan the two-dimensional code; and
determining, by the mobile terminal, that the client terminal logs into the website through the two-dimensional code upon a receipt of the command.

4. The method of claim 2, further comprising:
receiving, by the mobile terminal, a login request initiated by the client terminal;
displaying, by the mobile terminal, a login interface for a user of the client terminal to input second user information; and
receiving, by the mobile terminal, the second user information input by the user in the login interface.

5. The method of claim 4, further comprising:
determining, by the mobile terminal, whether a user of the client terminal is a code scanning login user by using the second user information; and
executing, by the mobile terminal, a process of acquiring the security identification corresponding to the client terminal, in response to determining that the user of the client terminal is the code scanning login user, the code scanning login user being a user who is authorized or capable to log into the website through the two-dimensional code by using the client terminal.

6. The method of claim 5, wherein the determining, by the mobile terminal, whether the user of the client terminal is the code scanning login user by using the second user information comprises:
determining, by the mobile terminal, that the client terminal is allowed to log into the website through the two-dimensional code, in response to determining that the second user information input by the user in the login interface is identical with the first user information recorded in the corresponding relationship.

7. The method of claim 6, wherein the determining, by the mobile terminal, whether the user of the client terminal is the code scanning login user by using the second user information comprises:
determining, by the mobile terminal, that the client terminal is allowed to log into the website through the two-dimensional code, in response to determining that the client terminal which logs into the website again is identical with the client terminal recorded in the corresponding relationship.

8. The method of claim 1, wherein determining, by the mobile terminal, that the client terminal is allowed to log into the website through a two-dimensional code comprises:
performing, by the mobile terminal, a verification of the first user information; and
determining, by the mobile terminal, that the user is not a code scanning login user, in response to determining that the verification fails.

9. The method of claim 8, further comprising:
querying, by the mobile terminal, a user database by using the first user information, the user database recording a corresponding relationship among the first user information, user login modes and user description information, in response to determining that the verification succeeds; and
determining, by the mobile terminal, that the user is not the code scanning login user in response to determining that the second user information is not recorded in the user database.

10. The method of claim 9, further comprising:
determining, by the mobile terminal, a user login mode corresponding to the first user information, in response to determining that the first user information is recorded in the user database; and
determining, by the mobile terminal, that the user is not the code scanning login user in response to determining that the user login mode corresponding to the first user information does not support code scanning login.

11. The method of claim 10, wherein the determining, by the mobile terminal, the user login mode corresponding to the first user information comprises determining that the mobile terminal supports scanning the two-dimensional code.

12. The method of claim 10, further comprising:
determining, by the mobile terminal, the user description information corresponding to the first user information, in response to determining that the user login mode corresponding to the first user information supports code scanning login; and
determining, by the mobile terminal, that the user is not the code scanning login user, in response to determining that the user description information corresponding to the first user information is a non-wireless area user.

13. The method of claim 12, further comprising:
determining, by the mobile terminal, that the user is the code scanning login user, in response to determining that the user description information corresponding to the second user information is a wireless area user.

14. The method of claim 1, further comprising:
acquiring, by the mobile terminal, a security identification corresponding to the client terminal by using the first user information; and
recording a corresponding relationship between the first user information and the security identification, the security identification being a unique identification corresponding to the client terminal.

15. The method of claim 14, further comprising:
receiving, by the mobile terminal, a command from the client terminal to scan the two-dimensional code;
scanning the two-dimensional code to obtain the security identification corresponding to the two-dimensional code; and
querying the corresponding relationship between the first user information and the security identification corresponding to the two-dimensional code to acquire the first user information.

16. The method of claim 1, wherein the security identification has an expiration time.

17. The method of claim 1, wherein the two-dimensional code has an expiration time.

18. A mobile terminal comprising:
a recording module that, after a client terminal on the mobile terminal successfully logs into a website through user information and password information, records a corresponding relationship between the client terminal and the user information;
a determining module that, when the client terminal logs into the website again, determines that the client terminal is allowed to log into the website through a two-dimensional code by using the corresponding relationship;
an acquiring module that acquires a security identification corresponding to the client terminal; and
a generating module that generates a two-dimensional code by using the security identification and displays the two-dimensional code.

19. The mobile terminal of claim 18, further comprising:
a receiving module that receives a command from the client terminal to scan the two-dimensional code; and
a logging-in module that, upon a receipt of the command, determines that the client terminal logs into the website through the two-dimensional code.

20. One or more memories having stored thereon computer-executable instructions executable by one or more processors to perform operations comprising:
recording a corresponding relationship between a client terminal and first user information after the client terminal at the mobile terminal successfully logs into a website;
determining that the client terminal is allowed to log into the web site through a two-dimensional code by using the corresponding relationship when the client terminal logs into the web site again;
acquiring a security identification corresponding to the client terminal;
generating the two-dimensional code by using the security identification; and
displaying the two-dimensional code.
